(19) United States
(12) Patent Application Publication
(10) Pub. No.: US 2013/0048796 A1
(43) Pub. Date: Feb. 28, 2013

(54) Dock for Cord Organization

(71) Applicant: Robin Peng, South Jordan, UT (US)

(72) Inventor: Robin Peng, South Jordan, UT (US)

(73) Assignee: JUPITER IP, LLC, Sandy, UT (US)

(21) Appl. No.: 13/594,627

(22) Filed: Aug. 24, 2012

Related U.S. Application Data
(60) Provisional application No. 61/527,435, filed on Aug. 25, 2011.

(51) Int. Cl. F16L 3/01

(52) U.S. Cl. 248/56

(57) ABSTRACT

The present invention is a dock for electrical cords and cables. It comprises a truncated cylinder made of an elastomeric material, having an elliptical base and a circular face. A slit is formed in the longer side of the dock and an axial bore is present, allowing the dock to flex and accommodate various cords. Ideally, the slit is wider at the base, forming a passage, and the circular face is concave, allowing for larger numbers and sizes of cords and cord heads to be contained.

### FIELD OF THE INVENTION

The present invention relates to the field of electrical cords and cables and more particularly relates to a cord dock used to manage the placement and organization of electrical cords and cables in an area.

### BACKGROUND OF THE INVENTION

Since the invention of string and cord, there has been a need to manage and organize cords so that they would not become a tangled mess. This need did not change when electrical cords and cables were invented and, as our society uses more and more cables and cords, the need has only grown. Many devices and inventions have been made to assist users in the management and organization of cords and cables, including the APPLECORE, U.S. Pat. No. 7,651,047 (2010) and U.S. Pat. No. 7,661,623 (2010), an elastomeric spooling device with two bulbous ends and a retention slit and channel structure in each end. However, while precious solutions to cord management work well in maintaining cords in a controlled and organized manner, they do have one drawback—they still move. Movement by a cord bundle is not necessarily prevented by organization tools and methods and movement off of a work surface by a cord bundle can damage a cord if it is left with a large dangling mass of cord and organizer in mid-air. What is needed then, is a way to not only keep cords organized, but also keep them in one place.

The present invention is a dock for cord organization (or “cord dock”) and, in its best mode, is designed for synergistic use with the aforementioned APPLECORE device. The present invention represents a departure from the prior art in that the cord dock of the present invention allows for not only cord organization, but also for static placement of cords in a manner that they do not travel, fall or otherwise move from a place where they have been located. The cord dock of the present invention may also be used for other functions, such as a support system for consumer electronics and laptop computers.

### SUMMARY OF THE INVENTION

In view of the foregoing disadvantages inherent in the known types of cord management devices, this invention provides a cord dock for cords and cord management devices. As such, the present invention's general purpose is to provide a new and improved cord dock for cords that is easy to use, will hold a number of cords and/or a cord management device(s) and keep said cords and/or cord management device in one location.

To accomplish these objectives, the cord dock comprises an elastomeric truncated cylinder with an axial bore, a circular base and a non-circular, elliptical face. While it is well known that a circle is, in fact, an ellipse, this Application and the appended claims shall use the term “elliptical face” to exclusively refer to the non-circular face of the truncated cylinder. The truncation of the cylinder produces a short front side and a taller rear side. A slit is cut from the axial bore through truncated cylinder body's rear side. This then creates a passage area for cords while also turning the elliptical face into a containment surface. The preferred embodiment also features a bowl, further formed into the elliptical face, which increases stowage capacity so that the cord dock may contain larger numbers of cords or may contain a cord management device such as the aforementioned APPLECORE.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a preferred embodiment of a cord dock according to the present invention.

FIG. 2 is an alternate perspective view of the cord dock of FIG. 1.

FIG. 3 is a right elevation of the cord dock of FIG. 1.

FIG. 4 is a front elevation of the cord dock of FIG. 1.

FIG. 5 is a rear elevation of the cord dock of FIG. 1, with phantom lines depicting internal curvature.

FIG. 6 is a bottom plan view of the cord dock of FIG. 1.

FIG. 7 is a top plan view of the cord dock of FIG. 1.

FIG. 8 is a sectional view of the cord dock of FIG. 6, taken along line A-A.

FIG. 9 is a perspective view of the cord dock of FIG. 1, in use with two electrical cords.

FIG. 10 is a perspective view of the cord dock of FIG. 1, in combination with an APPLECORE cord management device.

### DETAILED DESCRIPTION OF THE PREFERRED EMBODIMENT

With reference now to the drawings, the preferred embodiment of the dock for cord management is herein described. It should be noted that the articles “a”, “an”, and “the”, as used in this specification, include plural referents unless the content clearly dictates otherwise.

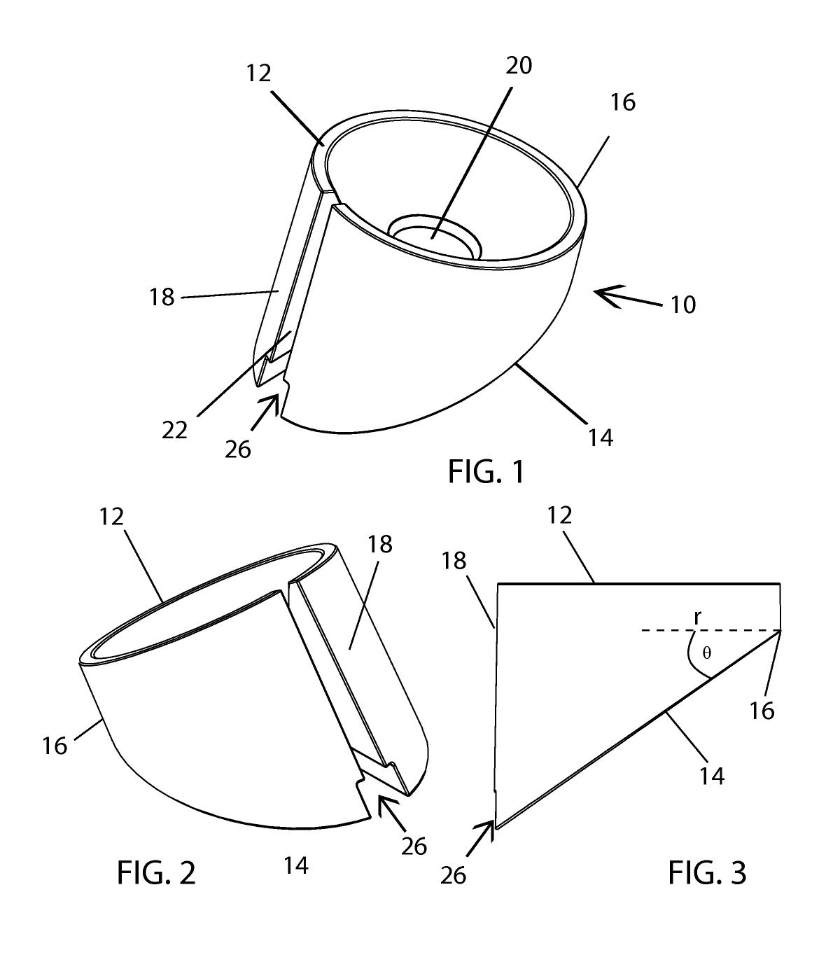

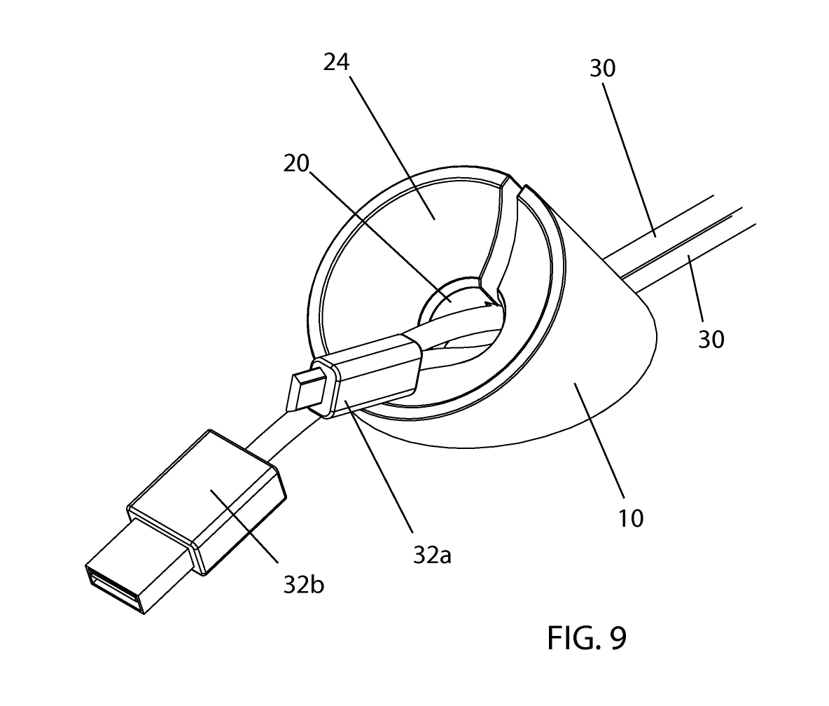

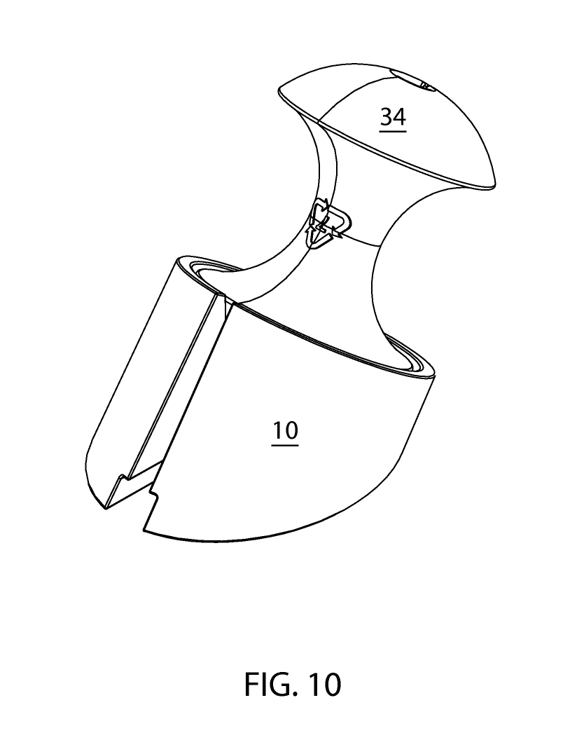

With reference to FIGS. 1 and 2, the cord dock 10 takes the general form of a truncated right cylinder, which is to say a right cylinder with a circular face 12 and a non-circular, elliptical base 14, non-parallel thereto. The truncation creates a front side 16 that is shorter than the rear side 18. The cord dock also comprises an axial bore 20 and a slit 22 emanating from the axial bore 20 through the rear side 18 of the cord dock 10. This slit 22, with the elastomeric properties of the cord dock, allows the cord dock 10 to flex and accommodate cords 30 with heads 32a, 32b (FIG. 9) larger than the axial bore. It also allows cords 30 of larger diameter than the width of the slit 22 to be accommodated.

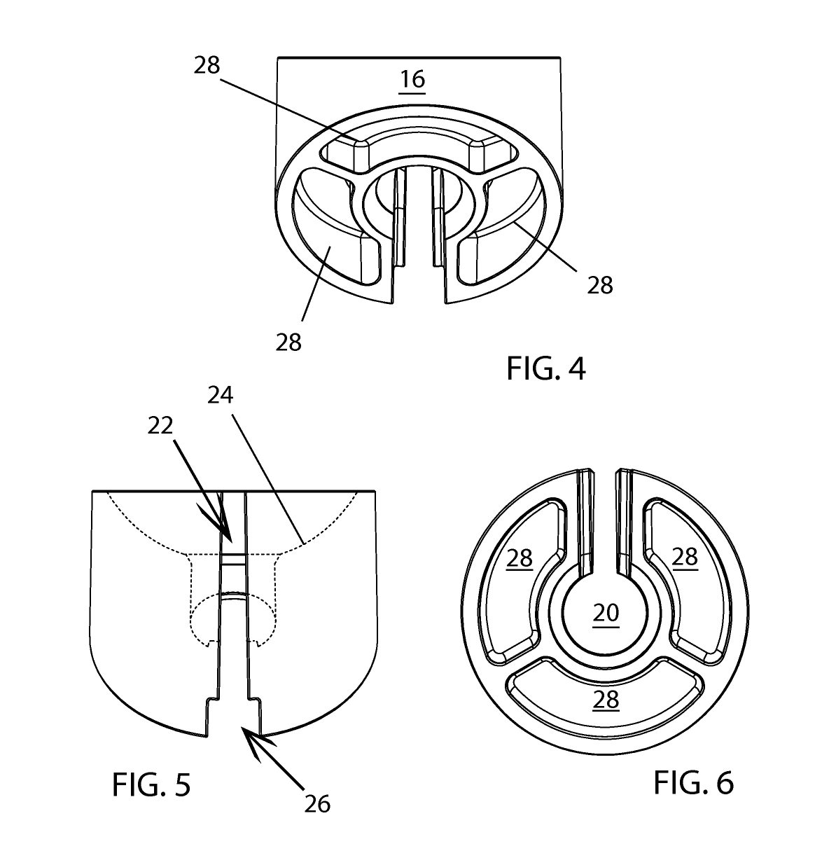

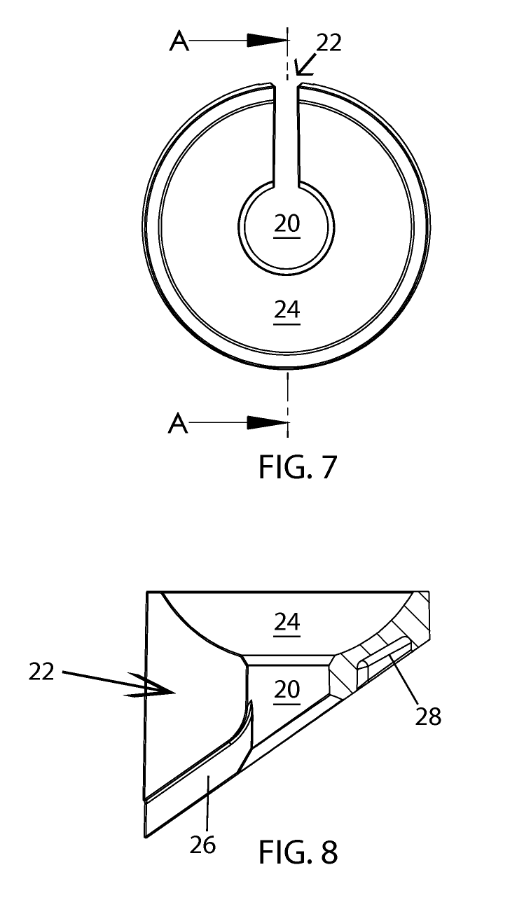

Certain features add to the utility of the cord dock 10. First, a passage 26 may be fashioned along the slit 22 in the elliptical base 14, shown in FIGS. 3-6. The passage 26, best illustrated in FIG. 8, accommodates cord widths (from one or a plurality of cords) larger that the slit 22 is wide. In so doing, not only are such cords accommodated, but they are also positioned along the base of the cord dock 10. Further, the circular face 12 may be concave, forming a bowl 24. The bowl 24 serves to better contain cord plugs 32a, 32b when cords 30 are therein inserted, as shown in FIG. 9, as well as larger cord management devices. The curvature of the bowl may be designed to be roughly commensurate with that of an APPLECORE. In so doing, an APPLECORE 34, or any other cord management device, may be used to secure a cord and also sit inside the bowl 24, as shown in FIG. 10. In the case of the APPLECORE, it will maintain a somewhat erect position due to the complimentary curvature.

A durable elastomeric compound forms the body of the dock. Not only will this allow the dock to flex about the slit 22 and so accommodate cords 30 therethrough, but it will also provide a larger coefficient of friction between the dock and a surface upon which it is placed. This then will hold it in position better. The angle θ the elliptical face makes with a radius r of the cylinder is preferred to be about 32°, though a variation of a couple of degrees is possible (FIG. 3). This particular acute angle allows the APPLECORE to maintain its erect position and also serves as a small enough angle to keep cords from bending when positioned in the dock, while also providing a normal force if a cord is tugged. When combined with a short height and the bowl 24, the general angle θ also allows the dock to serve as a dock or foot for other objects, such as a laptop computer or other electronic devices. Simply placing each corner of the device inside a dock provides a skid resistant and stable support for the device.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A cord dock comprising:
a. a truncated cylinder, an elliptical face being defined as a base and the truncation defining a short side and a long side;
b. a circular face of the truncated cylinder being hollowed into a bowl;
c. an axial bore running through the cylinder; and
d. a slit extending from the axial bore through to a side of the truncated cylinder.

2. The cord dock of claim 1, further comprising a passage along the length of the slit on the base.

3. The cord dock of claim 2, the elliptical face being at about a 32° angle relative to a radius of the cylinder.

4. The cord dock of claim 1, the elliptical face being at about a 32° angle relative to a radius of the cylinder.
